(19) United States
(12) Patent Application Publication
(10) Pub. No.: US 2013/0331098 A1
(43) Pub. Date: Dec. 12, 2013

(54) Automatically Determining and Alerting Users to Available Wireless Networks

(71) Applicant: Apple Inc., Cupertino, CA (US)

(72) Inventors: Saravanan Balasubramaniyan, Los Gatos, CA (US); Kapil Chhabra, Milpitas, CA (US); Andreas Wolf, San Mateo, CA (US); Tito Thomas, San Jose, CA (US)

(21) Appl. No.: 13/912,616

(22) Filed: Jun. 7, 2013

Related U.S. Application Data
(60) Provisional application No. 61/657,564, filed on Jun. 8, 2012.

(51) Int. Cl. H04W 48/20

(52) U.S. Cl. CPC H04W 48/20
USPC 455/434

(57) ABSTRACT

Automatically determining and alerting a user to available wireless networks. Initially, the method may automatically determine that one or more wireless networks are available to a wireless device at a location. The method may determine if the wireless device has been present at the first location for more than a threshold amount of time, e.g., based on periodic determination of the available wireless networks to the wireless device. Based on the wireless device being present at the first location for more than the threshold amount of time, an alert may be automatically displayed to the user on a display of the wireless device. The alert may indicate at least one wireless network of the one or more wireless networks at the first location. The wireless device may connect to wireless network indicated by the alert in response to user input.

### PRIORITY CLAIM

The present application claims benefit of priority to U.S. Provisional Application No. 61/657,564 titled “Automatically Determining and Alerting Users to Available Wireless Networks” and filed on Jun. 8, 2012, whose inventors are Saravanan Balasubramaniyan, Kapil Chhabra, Andreas Wolf, and Tito Thomas, and which is hereby incorporated by reference in its entirety as thought fully and completely set forth herein.

### FIELD

The present disclosure relates to wireless communication, and more particularly to a system and method for automatically determining and alerting users to available wireless networks.

### DESCRIPTION OF THE RELATED ART

Presently, many user devices, such as cell phones, tablet computers, etc., provide alerts in certain scenarios. For example, many user devices have the ability to join wireless networks, such as 802.11 wireless networks. Accordingly, current user devices may provide a user alert to join a wireless network when a data connection is required. However, such an “ask-to-join” alert is intrusive in many scenarios, e.g., occurring when a user is driving and requests driving connections using a cellular connection, particularly when no 802.11 network is actually available. Similar other alerts may also be intrusive. Accordingly, improvements in user interactions with devices are desired.

### SUMMARY

Various embodiments are described of a system and method for automatically determining and alerting a user to available wireless networks.

Initially, one or more wireless networks may be automatically detected by a wireless device. For example, the wireless device may scan for signals, e.g., beacons, from wireless networks within range of the wireless device.

The detection of the wireless networks may be performed, e.g., automatically, multiple times to detect a plurality of wireless networks. For example, the wireless device may periodically scan for wireless networks, e.g., every few minutes, half an hour, hour, etc. In one embodiment, during each scan, the detected wireless networks may be stored, e.g., for later analysis.

One or more criteria may be applied to the determined wireless networks to produce a set of one or more wireless networks that pass the criteria. For example, the criteria may include that the wireless device has been within range of a same or overlapping set of wireless network(s) for more than a threshold period of time. As another example, the criteria may include whether the wireless device has been within range of the same set of wireless network(s) for a cumulative amount of time greater than a threshold of time. Further, the criteria may include how long or how often the wireless device is at a particular location having the detected wireless networks. Any of various criteria may be applied to the detected wireless networks.

Accordingly, an alert may be provided to a user of the wireless device for one or more wireless networks from the set of wireless network(s) that pass the criteria. Finally, the wireless device may connect to or join a wireless network indicated by the alert, based on user input received to the wireless device.

### BRIEF DESCRIPTION OF THE DRAWINGS

A better understanding of the present subject matter can be obtained when the following detailed description is considered in conjunction with the following drawings.

FIG. 1 illustrates an exemplary wireless communication system where multiple user devices communicate with an access point;

FIG. 2 illustrates an exemplary access point in communication with an exemplary wireless device;

FIG. 3 illustrates an exemplary block diagram of a wireless device;

FIG. 4 is a flowchart diagram illustrating an exemplary method for automatically determining and alerting a user to available wireless networks;

FIG. 5 is an exemplary user interface of an “ask-to-join” alert;

FIG. 6 is a flowchart diagram illustrating another exemplary method for automatically determining and alerting a user to available wireless networks;

FIG. 7 is a flowchart diagram illustrating an exemplary method for detecting and ranking wireless networks; and

FIG. 8 is a flowchart diagram illustrating an exemplary method for using different behavior profiles based on location.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terms

The following is a glossary of terms used in the present application:

Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Wireless Device—any of various types of computer systems devices which are mobile or portable and which performs wireless communications. Examples of wireless devices include mobile telephones or smart phones (e.g., iPhone™, Android™-based phones), portable gaming devices (e.g., Nintendo DS™, PlayStation Portable™, Gameboy Advance™, iPhone™), laptops, PDAs, portable Internet devices, music players, data storage devices, or other handheld devices, etc. In general, the term “wireless device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element—refers to various elements or combinations of elements. Processing elements include, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

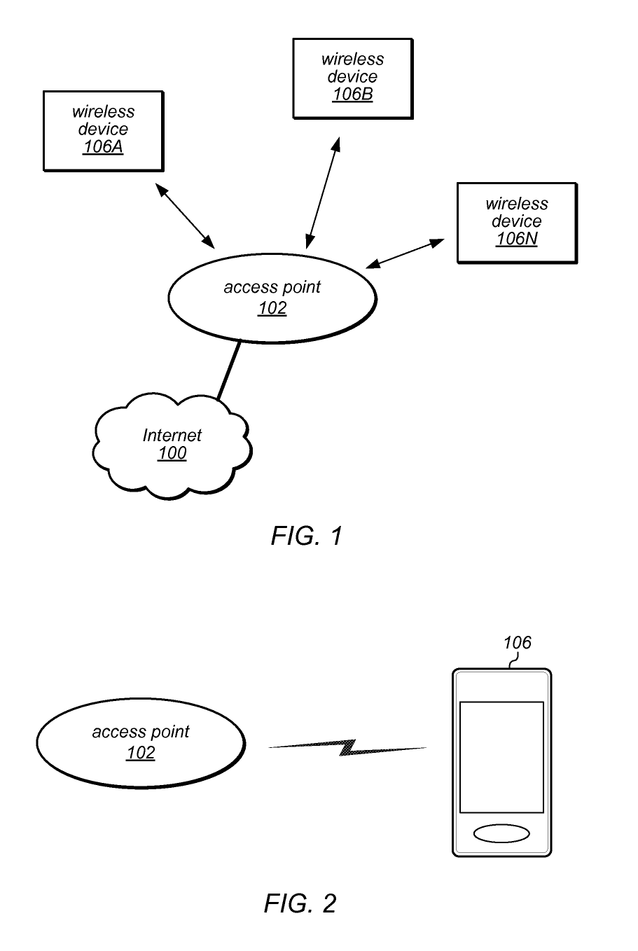

### FIGS. 1 and 2—Exemplary Communication System

FIGS. 1 and 2 illustrate an exemplary (and simplified) wireless communication system. It is noted that the system of FIG. 1 is merely one example of a possible system, and embodiments may be implemented in any of various systems, as desired.

As shown, the exemplary wireless communication system includes an access point 102 which communicates over a transmission medium with one or more wireless devices 106A through 106N. In some embodiments, the access point 102 may be a 802.11 (e.g., a, b, g, n, ac, etc.) wireless access point, or may be an access point of another wireless protocol (e.g., WiMAX, GSM, CDMA, LTE, etc.). The access point 102 may provide a connection to another network, such as the Internet 100. Thus, the access point 102 may allow wireless devices 106A-106N to communicate with the Internet 100.

FIG. 2 illustrates wireless device 106 (e.g., one of the devices 106A through 106N) in communication with the access point 102. The wireless device 106 may be a device with wireless network connectivity such as a mobile phone, a hand-held device, a computer or a tablet, or virtually any type of wireless device. The wireless device 106 may include a processor that is configured to execute program instructions stored in memory. The wireless device 106 may perform any of the embodiments described herein by executing such stored instructions. In some embodiments, the wireless device 106 may include a programmable hardware element such as an FPGA (field-programmable gate array) that is configured to perform any of the method embodiments described herein, or any portion of any of the method embodiments described herein.

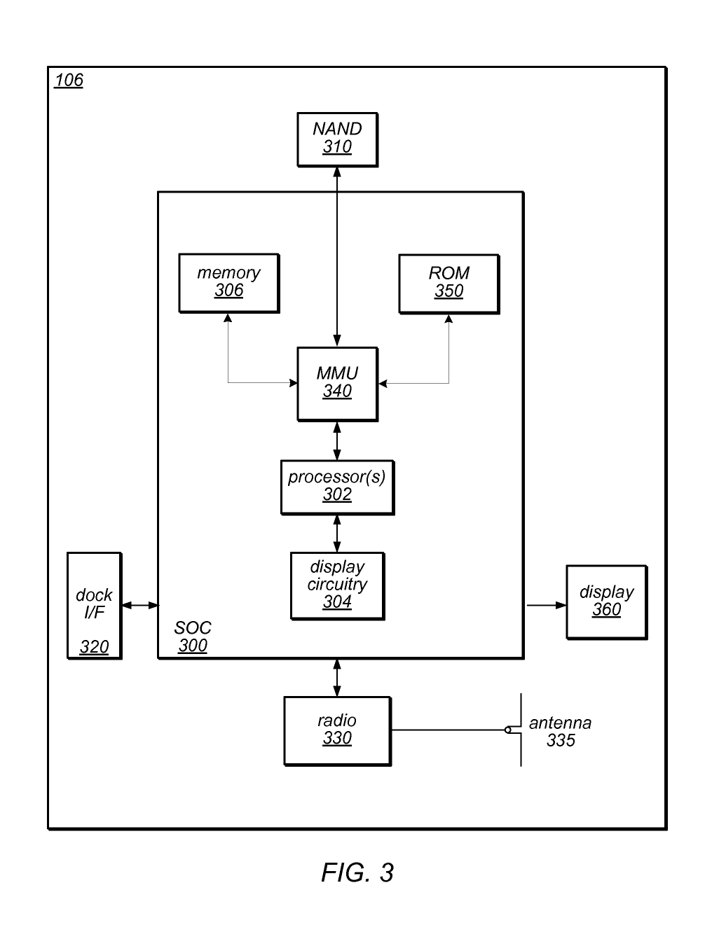

### FIG. 3—Exemplary Block Diagram of a Wireless Device

FIG. 3 illustrates an exemplary block diagram of a wireless device 106. As shown, the wireless device 106 may include a system on chip (SOC) 300, which may include portions for various purposes. For example, as shown, the SOC 300 may include processor(s) 302 which may execute program instructions for the wireless device 106 and display circuitry 304 which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector I/F 320, and/or display 360. The MMU 340 may be configured to perform memory protection and page table translation or set up. In some embodiments, the MMU 340 may be included as a portion of the processor(s) 302.

As also shown, the SOC 300 may be coupled to various other circuits of the wireless device 106. For example, the wireless device 106 may include various types of memory (e.g., including NAND flash 310), a connector interface 320 (e.g., for coupling to a computer system, dock, charging station, etc.), the display 360, and wireless communication circuitry (or “radio”) 330 (e.g., for LTE, LTE-A, CDMA2000, GSM, Bluetooth, WiFi, etc.) which may use antenna 335 to perform the wireless communication.

The UE 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving/interpreting user input.

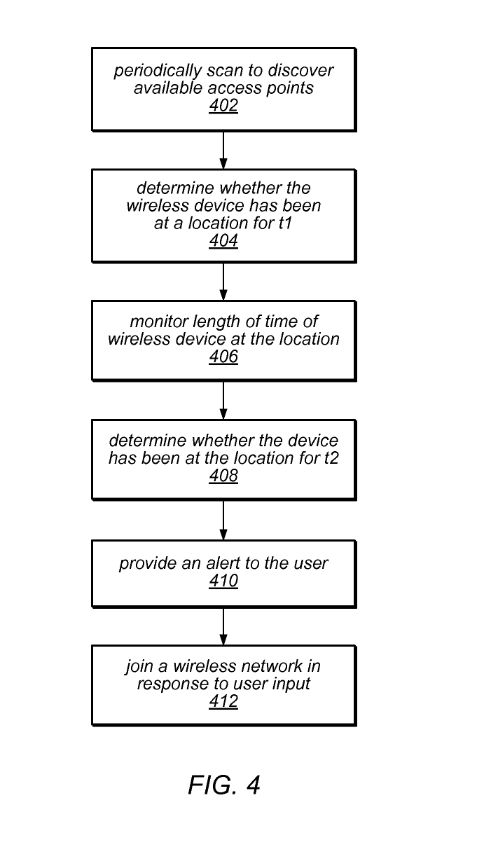

As described herein, the UE 106 may include hardware and software components for implementing features for automatically determining and alerting a user to available wireless networks, such as those described herein with reference to, inter alia, FIGS. 4-8. The processor 302 of the UE device 106 may be configured to implement part or all of the features described herein, e.g., by executing program instructions stored on a memory medium (e.g., a non-transitory computer-readable memory medium). Alternatively (or in addition), processor 302 may be configured as a programmable hardware element, such as an FPGA (Field Programmable Gate Array), or as an ASIC (Application Specific Integrated Circuit). Alternatively (or in addition) the processor 302 of the UE device 106, in conjunction with one or more of the other components 300, 304, 306, 310, 320, 330, 335, 340, 350, 360 may be configured to implement part or all of the features described herein, such as the features described herein with reference to, inter alia, FIGS. 4-8.

### FIG. 4—Exemplary Method for Alerting a User to Available Networks

FIG. 4 illustrates one embodiment of a method for automatically determining and alerting a user to available wireless networks. The method shown in FIG. 4 may be used in conjunction with any of the computer systems or devices shown in the above Figures, among other devices. In various embodiments, some of the method elements shown may be performed concurrently, in a different order than shown, or may be omitted. Additional method elements may also be performed as desired.

The particular embodiment of FIG. 4 may be applicable to the following scenario:

a) A user, using a wireless device, is located at a particular location. The method of FIG. 4 may be particularly applicable when the user is at a location where he spends a significant amount of time (e.g., more than an hour, perhaps routinely), although it may be applied whenever the following conditions are met.

b) One or more wireless networks (e.g., WiFi networks) are available at the location; and

c) The wireless device is not connected to one of the available wireless networks at the location.

In the following, the location of the wireless device may be identified according the wireless networks or access points (described below with respect to access points) available to the wireless device. In other words, while the particular physical location may be unknown (e.g., such as the GPS coordinates), the location may be described by identifying the access points that are available at that location. This set of available access points may uniquely identify the particular location. In one embodiment, the set of access points may be represented using the set of BSSID (Basic Service Set Identifier, e.g., the MAC addresses) of the access points.

As shown, this method may operate as follows.

In 402, the wireless device may periodically scan, e.g., automatically, to discover available access points. For example, the wireless device may scan every few minutes, 5 minutes, 15 minutes, 30 minutes, an hour, etc. to determine the currently available access points.

In 404, the method (e.g., the wireless device) may automatically determine whether the wireless device has been at a location for a first threshold amount of time (e.g., 5 minutes, 15 minutes, 30 minutes, an hour, etc.), labeled t1. As discussed above, determining whether the device has been at a location for t1 may be based on the set (one or more) of access points available to the wireless device. For example, at each period, the current set of available access points may be compared to the set of available access points from the previous period. If the sets overlap (e.g., having at least one common access point), substantially match (e.g., having greater than 60% common access points), and/or completely match (e.g., having 100% common access points), according to various embodiments, then it may be determined that the wireless device has been at the same location for at least the period time length, which may be the same as t1, in some embodiments. Where the period does not match t1, the method may simply compare the current set of access points to the set of access points available t1 ago, similar to discussions above.

In 406, assuming the wireless device has been at the location for at least t1, the wireless device may automatically monitor the length of time at that location. Note that the monitoring may be for a single sitting (e.g., which may be forgotten or reset, should the user leave the area) or may be cumulative (e.g., where the total time at the location is kept track of, regardless of if or how often the user leaves and returns).

For example, the wireless device may store information indicating a location (e.g., characterized by the wireless networks present at the location) and/or the amount of time at a location, e.g., based on the periodic scanning in 402 above. For example, after exceeding the time t1, a location entry may be created indicating the wireless networks present at the location as well as the total time (for a single sitting and/or cumulative).

In 408, the method (e.g., the wireless device) may automatically determine whether the wireless device has been at the location for a second threshold of time (e.g., 5 minutes, 15 minutes, 30 minutes, 1 hour, 5 hours, etc.), labeled t2. For example, this determination may be based on an entry that was created in 406 after t1 was passed. As discussed above, the monitoring may be for a single sitting or may be cumulative. In one cumulative embodiment, the threshold t2 may be 5 hours.

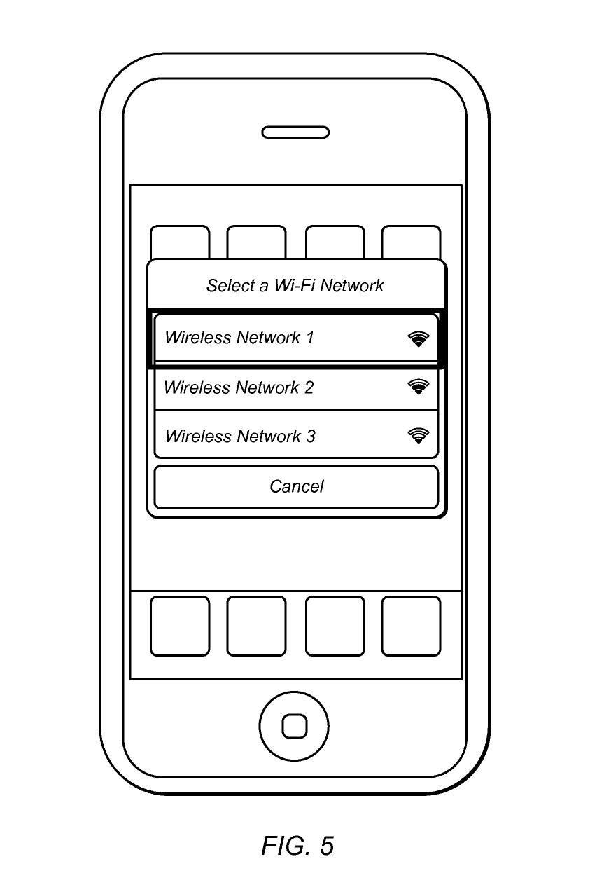

In 410, if the wireless device has been at the location for t2, then an alert may be presented to the user, e.g., on a display of the wireless device. More specifically, an ask-to-join dialog may be presented to the user on the display of the wireless device. FIG. 5 illustrates an exemplary “ask-to-join” dialog, where the user may select one of three available WiFi networks.

In one embodiment, such a dialog may only be presented once for any monitored location. This embodiment may apply for each sitting in the single sitting embodiments or may apply only once for cumulative embodiments. In other words, for single sitting monitoring, the dialog may only be presented once per sitting, but in cumulative embodiments, the dialog may only be presented once, total.

In 412, in response to user input selecting a wireless network of the alert (e.g., the ask-to-join dialog), the wireless device may join the wireless network.

While the above is described with respect to two different thresholds, it may be simplified to determining whether the wireless device has been at the location for a single threshold, and presenting the ask-to-join dialog after exceeding that threshold. However, in cumulative embodiments, the two thresholds may be preferable as it may limit the number of monitored locations for the wireless device.

Additionally, other methods for determining location (e.g., GPS circuitry, cell triangulation, access point location databases, etc.) may be used to determine and monitor the location. The location may be determined multiple times and used to determine whether the wireless device has been at a location for t1 and/or t2, similar to discussions above using wireless networks. However, using the wireless networks may be desirable since it may use less power (e.g., for battery considerations) than other methods for determining locations. Additionally, the use of the wireless networks for the location may be particularly useful for the embodiment of FIG. 4, since the alert (e.g., the ask-to-join alert) relates to wireless networks.

Note that the locations and durations may be stored in volatile memory. Accordingly, this information may be lost from reboot to reboot, e.g., but may be kept when only put to sleep. In alternate embodiments, the information may be stored across reboots (e.g., stored in non-volatile memory).

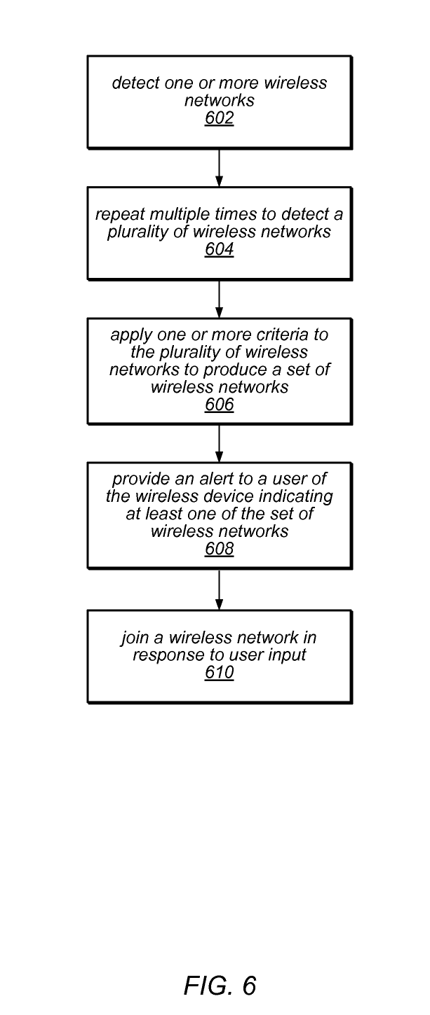

### FIG. 6—Automatically Determining and Alerting a User to Available Networks

FIG. 6 illustrates another embodiment of a method for automatically determining and alerting a user to available wireless networks. The method shown in FIG. 6 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

In 602, one or more wireless networks may be automatically detected by a wireless device. For example, the wireless device may scan for signals, e.g., beacons, from wireless networks within range of the wireless device.

In 604, 602 may be performed, e.g., automatically, a plurality of times to detect a plurality of wireless networks. For example, the wireless device may periodically scan for wireless networks, e.g., every few minutes, half an hour, hour, etc. In one embodiment, during each scan, the detected wireless networks may be stored, e.g., for later analysis.

In 606, one or more criteria may be applied to the plurality of wireless networks determined in 604 to produce a set of one or more wireless networks that pass the criteria. For example, the criteria may relate to the embodiments discussed above, regarding FIG. 4. Following such embodiments, the criteria may include that the wireless device has been within range of a same or overlapping set of wireless network(s) for more than a threshold period of time. For example, the criteria may include whether the wireless device has been within range of the same set of wireless network(s) for a cumulative amount of time greater than a threshold of time. Further, the criteria may include how long or how often the wireless device is at a particular location having the detected wireless networks.

In 608, an alert may be provided to a user of the wireless device for one or more wireless networks from the set of wireless network(s) that pass the criteria.

In 610, the wireless device may connect to or join a wireless network indicated by the alert, based on user input received to the wireless device.

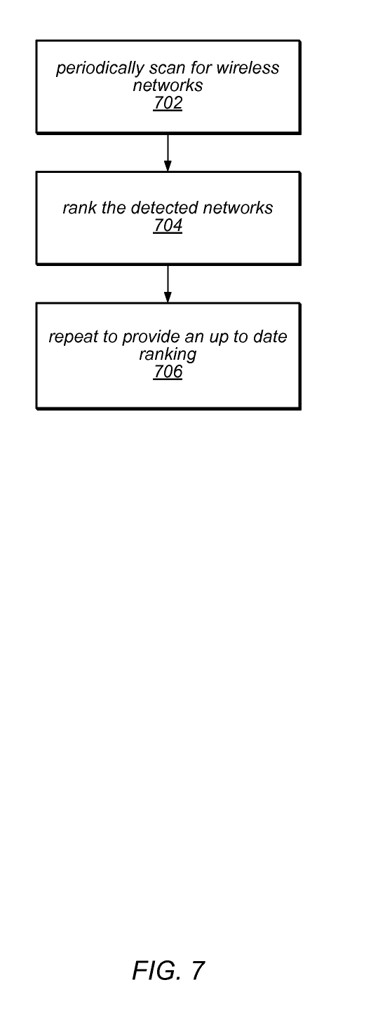

### FIG. 7—Exemplary Method for Detecting and Ranking Wireless Networks

FIG. 7 illustrates another particular embodiment of a method for detecting and ranking wireless networks. The method shown in FIG. 7 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

In 702, a wireless device may periodically scan (e.g., every 1 hour) and discover available wireless networks.

In 704, the detected wireless networks may be ranked. For example, the network that is found the most based on previous scans may be ranked first and so on.

In 706, 702 and 704 may be repeated. This repeated scanning and ranking may yield the wireless networks in whose range the wireless device spends the most time. For example, given that any user is likely to spend most of his time at either office or work, performing the above two steps for a given period of time may help determine the list of networks to which the client is likely to connect when the user is at their home/work or some other often visited location.

Since a given access point (e.g., at home or work) can be configured to advertise multiple wireless networks, the ranking mechanism can be falsely led to rank the networks from the same AP as the most often viewed network. In one embodiment, in order to overcome this issue, all wireless networks detected in a given area may be tagged as a single entity. Accordingly, that entity may be ranked instead of individual wireless networks. Thus, a scan revealing any network which is part of the entity will boost the rank of the entity against any individual wireless network.

Alternatively, or additionally, a location tag may be assigned to a given area and all the wireless networks found in that area may be classified under that location tag. Accordingly, location tags may be ranked against individual networks. For example, any network found in a scan may boost the rank of the location tag. The top ranked entity or the location tag may correspond to a place the wireless device spends most of its time. Consequently, the networks mapped to the entity or the location tag may be the appropriate networks for the client to connect to.

### ADVANTAGES

As discussed previously, some user alerts, such as “ask-to-join” alerts may be bothersome or intrusive to users. Accordingly, by following the embodiments described herein, the number of such alerts may be reduced dramatically, thereby relieving or at least reducing user frustration. For example, a user may not be constantly provided with an “ask-to-join” alert every time a wireless network is detected, but instead may only be presented one after various criteria has been passed. In one particular embodiment, a user may only be alerted with such “ask-to-join” alerts where the user spends significant time without connecting to one or more wireless networks available at that location (e.g., at a home or office of the user).

### Further Embodiments

While various embodiments discussed above relate to determining and alerting users to wireless networks, similar methods may be applied to other alerts. Even further, using information regarding time spent at various locations and/or detecting often visited locations may allow for different wireless device behaviors, such as using different behavior profiles for different locations and/or times of day. For example, an “on the go” behavior profile may be used while the wireless device is moving, e.g., consistently; a stationary behavior profile may be used while the user is in a same location for more than a threshold period of time; a work behavior profile may be used while the wireless device is relatively stationary during the day (e.g., in a location where the user is most often and/or when it is within business hours); a home behavior profile may be used while the wireless device is relatively stationary at night (e.g., in a location where the user is most often and/or when it is outside of business hours); a travel behavior profile may be used while the wireless device is outside of its normal location(s) and/or when airplane mode has been recently invoked, among other possibilities; a sleep behavior profile during normal sleeping hours and while the wireless device is stationary, etc.

The behavior profiles may be based on locations determined using wireless networks (e.g., similar to the embodiments discussed above), GPS, cell tower triangulation, etc. For example, the fact that the user has not changed his location (e.g., based on detected wireless networks) may allow the wireless device to use a new behavior profile (e.g., rather than a default profile). Similarly, an “often-visited”, work, or home profile may be used based on the detected wireless networks (e.g., where the set of wireless networks indicates a work place, home, favorite coffee shop, etc.). Additionally, the wireless network alert behavior may be specified in the behavior profile(s), e.g., where the behavior discussed above applies to work or home behavior profiles. For example, the methods discussed above may be used to determine that the user is at home or work, and the way the alert is presented may be specified in the home or work behavior profile.

Exemplary other behaviors specified in the profiles may include different ring tones at different locations or at different times of the day. For example, during a sleep behavior profile, the ringer and alerts may be muted. Alternatively, while at different locations (e.g., home, work, traveling, etc.), different ring sets may be used. Further, the behavior profiles may specify different security settings: e.g., at home the phone may not require a pin or unlocking gesture to unlock the device and/or passwords may not be required, such as for purchases; while traveling, higher security may be applied; etc. Further, certain services may be initiated, e.g., a do not disturb mode for work emails or calendar notifications while the “home” or “travel” profile is active (or simply whenever the “work” profile is not active). Further types of behaviors are envisioned.

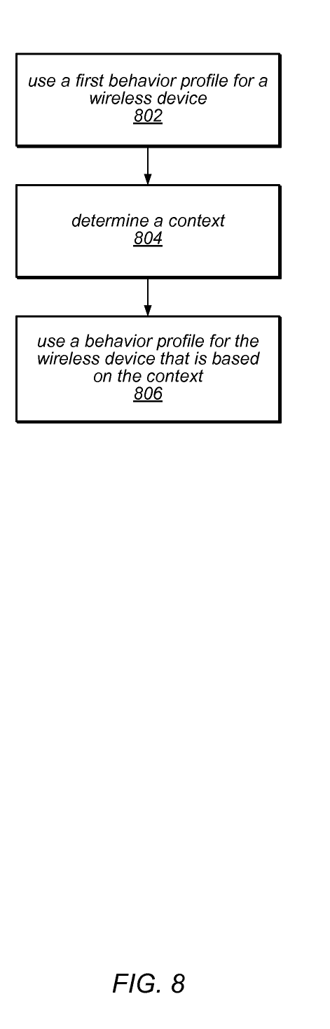

### FIG. 8—Using Different Behavior Profiles

FIG. 8 illustrates one embodiment of a method for using different behavior profiles for a wireless device. The method shown in FIG. 8 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, the method may operate as follows:

Initially, in 802, a first behavior profile may be used for a wireless device. For example, the first behavior profile may be a default behavior profile for the wireless device.

Later, in 804, a context may be determined. For example, the context may be that a user is at work (or at a constant location during working hours), is at home, is asleep (e.g., at home or at a constant location during sleeping hours), is traveling, etc. The determination of the context may be based on the user's location (e.g., using GPS, cell triangulation, WiFi Networks location directories, etc.), the time of day, etc. Additionally, or alternatively, the determination of the context may be based on the user staying in a location, e.g., as determined using various embodiments regarding wireless networks discussed above (although the particular physical location may not be known). The contexts may involve any of those discussed above, among others.

Accordingly, in 806, a behavior profile associated with the context of 804 may be used by the wireless device. The behaviors may involve any of those discussed above, e.g., regarding various contexts, such as working, traveling, stationary, sleeping, at home, etc. Other behaviors and behavior profiles are envisioned.

Embodiments of the present disclosure may be realized in any of various forms. For example some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a wireless device) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for a wireless device to automatically determine and alert a user to available wireless networks, the method comprising:
automatically determining one or more wireless networks available to the wireless device at a first location;
determining if the wireless device has been present at the first location for more than a first threshold amount of time;
based on the wireless device being present at the first location for more than the first threshold amount of time, automatically presenting an alert to the user on a display of the wireless device, wherein the alert indicates at least a first wireless network of the one or more wireless networks at the first location.

2. The method of claim 1, further comprising:
receiving user input indicating to connect to the first wireless network; and
connecting to the first wireless network in response to the user input.

3. The method of claim 1, wherein the method further comprises:
periodically scanning for available wireless networks;
wherein determining if the wireless device has been present at the first location for more than the first threshold amount of time is based on periodically scanning for available wireless networks.

4. The method of claim 1,
wherein the first location is characterized by wireless networks present at the location.

5. The method of claim 1,
wherein determining if the wireless device has been present at the first location for more than the first threshold amount of time is based determining one or more of:
geographic coordinates of the wireless device;
cellular triangulation; or
an access point location database.

6. The method of claim 1,
wherein the first threshold amount of time is one of:
a continuous amount of time; or
a cumulative amount of time.

7. The method of claim 1, the method further comprising:
ranking the one or more wireless networks available to the wireless device at the first location,
wherein the alert indicates at least the first wireless network of the one or more wireless networks at the first location based at least in part on ranking the one or more wireless networks available to the wireless device at the first location.

8. The method of claim 7,
wherein the first wireless network is indicated in the alert based at least in part on having a highest ranking of the one or more wireless networks available to the wireless device at the first location.

9. The method of claim 7, the method further comprising:
periodically scanning for available wireless networks;
re-ranking detected wireless networks for each respective periodic scan based on results of the respective scan and one or more previous scans.

10. A wireless device, the wireless device comprising:
a user interface;
a radio configured to perform communication using a first wireless communication technology; and
device logic coupled to the radio and the user interface;
wherein the device logic, the radio, and the user interface are configured to:
periodically scan for wireless networks available to the wireless device;
determine if one or more wireless networks are present for more than a first threshold of time;
associate the one or more wireless networks with a first location;
monitor length of time at the first location, wherein said monitoring length of time at the first location is based on the detected presence of the one or more wireless networks;
determine if the length of time at the first location exceeds a second threshold of time; and
provide an indication of at least one of the one or more wireless networks via the user interface based on the length of time at the first location exceeding the second threshold of time.

11. The wireless device of claim 10,
wherein determining if one or more wireless networks are present for more than the first threshold of time comprises comparing a current set of available wireless networks with a set of wireless networks available at one or more previous periodic scans for wireless networks available to the wireless device.

12. The wireless device of claim 10,
wherein said monitoring length of time at the first location comprises, at each periodic scan for wireless networks available to the wireless device:
comparing a current set of available wireless networks with a set of wireless networks available at one or more previous periodic scans for wireless networks available to the wireless device; and
determining if the current set of available wireless networks overlaps, substantially matches, or completely matches the set of wireless networks available at one or more previous periodic scans for wireless networks available to the wireless device based on said comparing.

13. The wireless device of claim 10,
wherein a length of the second threshold of time is greater than a length of the first threshold of time.

14. The wireless device of claim 10,
wherein a period length used for periodically scanning for wireless networks available to the wireless device is equal to a length of the first threshold of time.

15. The wireless device of claim 10, wherein the device logic, the radio, and the user interface are further configured to:
receive user input via the user interface, wherein the user input indicates to connect to a first wireless network of the at least one of the one or more wireless networks; and
connect to the first wireless network in response to the user input.

16. A non-transitory, computer accessible memory medium storing program instructions, wherein when executed by a wireless device, the program instructions cause a wireless device to:
automatically detect one or more wireless networks a plurality of times;
apply a first criteria to the one or more wireless networks to produce a set of wireless networks that pass the first criteria;
provide an alert to a user indicating at least one of the set of the wireless networks that pass the first criteria; and
connect to a first wireless network of the at least one of the set of the wireless networks that pass the first criteria in response to user input.

17. The memory medium of claim 16,
wherein the first criteria is selected based on a first behavior profile for the wireless device.

18. The memory medium of claim 17, wherein when executed by the wireless device, the program instructions further cause the wireless device to:
initially use the first behavior profile for the wireless device; and
at a second time:
determine that the wireless device is at a first location for more than a threshold amount of time;
use a second behavior profile for the wireless device based on the user device being at the first location for more than the threshold amount of time.

19. The memory medium of claim 18, wherein when executed by the wireless device, the program instructions further cause the wireless device to, at the second time:
automatically detect one or more wireless networks a plurality of times;
apply a second criteria to the one or more wireless networks to produce a set of wireless networks that pass the second criteria, wherein the second criteria is selected based on the second behavior profile for the wireless device; and
provide an alert to a user indicating at least one of the set of the wireless networks that pass the second criteria.

20. The memory medium of claim 16,
wherein the first criteria comprises the wireless device being within range of a same or overlapping set of wireless networks for more than a threshold amount of time.
